(19) United States
(12) Patent Application Publication
(10) Pub. No.: US 2024/0378874 A1
(43) Pub. Date: Nov. 14, 2024

(54) PANOPTIC SEGMENTATION WITH MULTI-DATASET TRAINING AND PART-WHOLE AWARENESS

(71) Applicant: NEC Laboratories America, Inc., Princeton, NJ (US)

(72) Inventors: Samuel Schulter, Long Island City, NY (US); Abhishek Aich, San Jose, CA (US)

(21) Appl. No.: 18/659,785

(22) Filed: May 9, 2024

Related U.S. Application Data
(60) Provisional application No. 63/465,627, filed on May 11, 2023.
(60) Provisional application No. 63/466,831, filed on May 16, 2023.
(60) Provisional application No. 63/599,175, filed on Nov. 15, 2023.

(51) Int. Cl. G06V 10/80; G06V 10/764; G06V 10/77; G06V 10/774; G06V 10/82; G06V 20/70

(52) U.S. Cl. CPC G06V 10/806; G06V 10/764; G06V 10/7715; G06V 10/774; G06V 20/70; G06V 10/82

(57) ABSTRACT

Systems and methods are provided for multi-dataset panoptic segmentation, including processing received images from multiple datasets to extract multi-scale features using a backbone network, each of the multiple datasets including a unique label space, generating text-embeddings for class names from the unique label space for each of the multiple datasets, and integrating the text-embeddings with visual features extracted from the received images to create a unified semantic space. A transformer-based segmentation model is trained using the unified semantic space to predict segmentation masks and classes for the received images, and a unified panoptic segmentation map is generated from the predicted segmentation masks and classes by performing inference using a panoptic interference algorithm.

### RELATED APPLICATION INFORMATION

This application claims priority to U.S. Provisional App. No. 63/465,627, filed on May 11, 2023; U.S. Provisional App. No. 63/466,831, filed on May 16, 2023; and U.S. Provisional App. No. 63/599,175, filed on Nov. 15, 2023, the contents of each of which are incorporated herein by reference in their entirety.

### BACKGROUND

### Technical Field

The present invention relates to image processing using panoptic segmentation, and more particularly to a system and method for enhancing multi-dataset segmentation accuracy by integrating language-based embeddings and dataset-specific adaptations in a transformer-based model.

### Description of the Related Art

In the field of computer vision, particularly in panoptic segmentation, traditional methods have concentrated on utilizing single-dataset training approaches that leverage distinct visual features and semantic annotations specific to that dataset. These conventional systems, while effective within their specific label spaces, falter when tasked with integrating and interpreting semantic information across multiple datasets with varying and potentially conflicting annotations. The challenge intensifies as these methods struggle to handle the inconsistencies and overlaps in label spaces that naturally occur when training across diverse datasets. This limitation significantly restricts their usability in real-world applications where the ability to operate across heterogeneous data sources can be important. Furthermore, the dependence on comparatively large, manually annotated datasets for training not only incurs high labor costs but also limits the scalability and adaptability of segmentation models, particularly in scenarios requiring rapid deployment across varied operational environments in real-time. Thus, there is a clear demand for advanced segmentation techniques that can robustly integrate and analyze panoptic data from multiple datasets, enhancing both the accuracy and the applicability of the segmentation results in diverse and dynamic settings.

### SUMMARY

According to an aspect of the present invention, a method is provided for multi-dataset panoptic segmentation, including processing received images from multiple datasets to extract multi-scale features using a backbone network, each of the multiple datasets including a unique label space, generating text-embeddings for class names from the unique label space for each of the multiple datasets, and integrating the text-embeddings with visual features extracted from the received images to create a unified semantic space. A transformer-based segmentation model is trained using the unified semantic space to predict segmentation masks and classes for the received images, and a unified panoptic segmentation map is generated from the predicted segmentation masks and classes by performing inference using a panoptic interference algorithm.

According to another aspect of the present invention, a system is provided for multi-dataset panoptic segmentation. The system includes a memory storing instructions that when executed by a processor device, cause the system to process received images from multiple datasets to extract multi-scale features using a backbone network, each of the multiple datasets including a unique label space, generate text-embeddings for class names from the unique label space for each of the multiple datasets, and integrate the text-embeddings with visual features extracted from the received images to create a unified semantic space. A transformer-based segmentation model is trained using the unified semantic space to predict segmentation masks and classes for the received images, and a unified panoptic segmentation map is generated from the predicted segmentation masks and classes by performing inference using a panoptic interference algorithm.

According to another aspect of the present invention, a computer program product is provided for multi-dataset panoptic segmentation, including instructions to process received images from multiple datasets to extract multi-scale features using a backbone network, each of the multiple datasets including a unique label space, generate text-embeddings for class names from the unique label space for each of the multiple datasets, and integrate the text-embeddings with visual features extracted from the received images to create a unified semantic space. A transformer-based segmentation model is trained using the unified semantic space to predict segmentation masks and classes for the received images, and a unified panoptic segmentation map is generated from the predicted segmentation masks and classes by performing inference using a panoptic interference algorithm.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a high-level view of a system and method for panoptic segmentation training using a multi-dataset part-whole awareness model, in accordance with embodiments of the present invention;

FIG. 3 is a diagram illustratively depicting a multi-dataset part-whole awareness pipeline for panoptic segmentation, in accordance with embodiments of the present invention;

FIG. 4 is a diagram illustratively depicting a high-level system and method for multi-dataset panoptic segmentation, in accordance with embodiments of the present invention;

FIG. 5A is a diagram illustratively depicting a system and method for multi-dataset panoptic segmentation training, in accordance with embodiments of the present invention;

FIG. 5B is a diagram illustratively depicting a system and method for multi-dataset panoptic segmentation inferencing, in accordance with embodiments of the present invention;

FIG. 6 is a diagram illustratively depicting a method for multi-dataset panoptic image segmentation training, in accordance with embodiments of the present invention;

FIG. 7 is a diagram illustratively depicting a method for multi-dataset panoptic segmentation, in accordance with embodiments of the present invention;

FIG. 8 is a diagram illustratively depicting a high-level view of a system and method for multi-dataset panoptic segmentation-based image processing across various computer vision and image processing tasks in multiple exemplary environments, in accordance with embodiments of the present invention; and

FIG. 9 is a diagram illustratively depicting a high-level view of a system for multi-dataset panoptic segmentation-based image processing, in accordance with embodiments of the present invention.

### DETAILED DESCRIPTION

In accordance with embodiments of the present invention, systems and methods are provided for enhancing panoptic segmentation models through the integration of multi-dataset training capabilities. The system and method can handle images from multiple datasets, each characterized by unique and potentially conflicting label spaces, to improve semantic understanding and model robustness. At its core, the invention integrates advanced transformer-based segmentation models with novel language-based embeddings and dataset-specific query embeddings. This integration allows the system to unify disparate semantic categories into a cohesive semantic space, which significantly boosts the accuracy and applicability of the segmentation results across diverse datasets.

The capability of the present invention extends beyond conventional single-dataset segmentation methods, as it adeptly resolves inconsistencies and overlaps in label spaces encountered during multi-dataset training. Through an enhanced decoding process, the model can dynamically adapt its segmentation predictions based on the specific dataset semantics at play, ensuring high fidelity in the generated panoptic maps. In some embodiments, the invention incorporates a novel inference algorithm that optimizes the handling of overlapping segmentation masks, thereby refining the final segmentation output. This mechanism ensures that the system not only performs segmentation but also intelligently resolves conflicts between competing annotations. Additionally, the system is supported by a robust computational framework that manages the complex tasks of feature extraction, embedding integration, and segmentation map generation. The system can include multiple components such as a data preprocessing unit, a feature extraction module, and an inference engine, all orchestrated to utilize cutting-edge AI techniques for managing and interpreting complex visual data across varied panoptic segmentation environments, in accordance with aspects of the present invention.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Aspects of the present invention are described below with reference to flowchart illustrations and/or block diagrams of methods, systems, and computer program products according to embodiments of the present invention. It is noted that each block of the flowcharts and/or block diagrams, and combinations of blocks in the flowcharts and/or block diagrams, may be implemented by computer program instructions.

The flowchart and block diagrams in the figures illustrate the architecture, functionality, and operation of possible implementations of systems, methods, and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

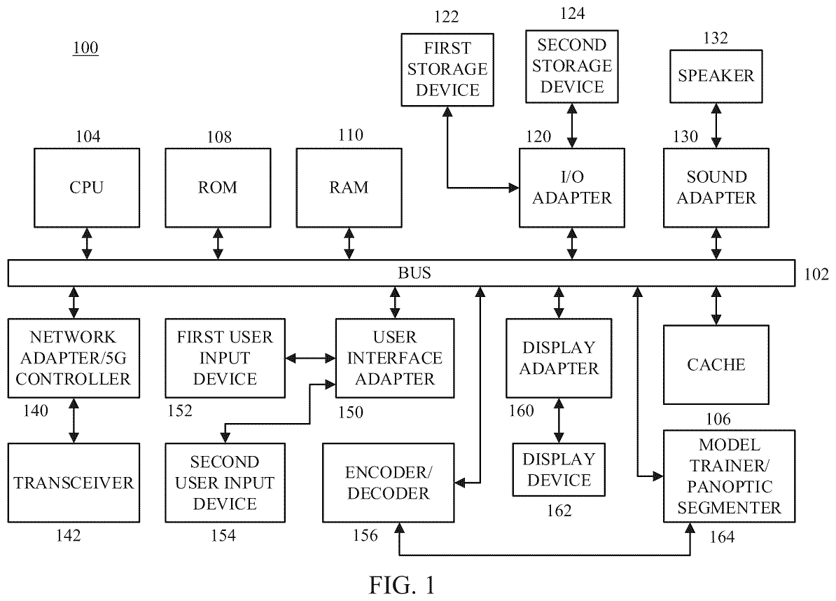

Referring now to the drawings in which like numerals represent the same or similar elements and initially to FIG. 1, an exemplary processing system 100, to which the present principles may be applied, is illustratively depicted in accordance with embodiments of the present principles.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. A Vision Language (VL) model can be utilized in conjunction with a predictor device 164 for input text processing tasks, and can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. An encoder and/or a decoder 156 can process received input and can be included in a system with one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. The encoder and/or decoder 156 can be utilized with a learnable neural network to work in conjunctions with a model trainer/panoptic segmenter 164, which can be operatively connected to the system 100 for any of a plurality of tasks (e.g., image classification, object detection, segmenting, etc.), in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

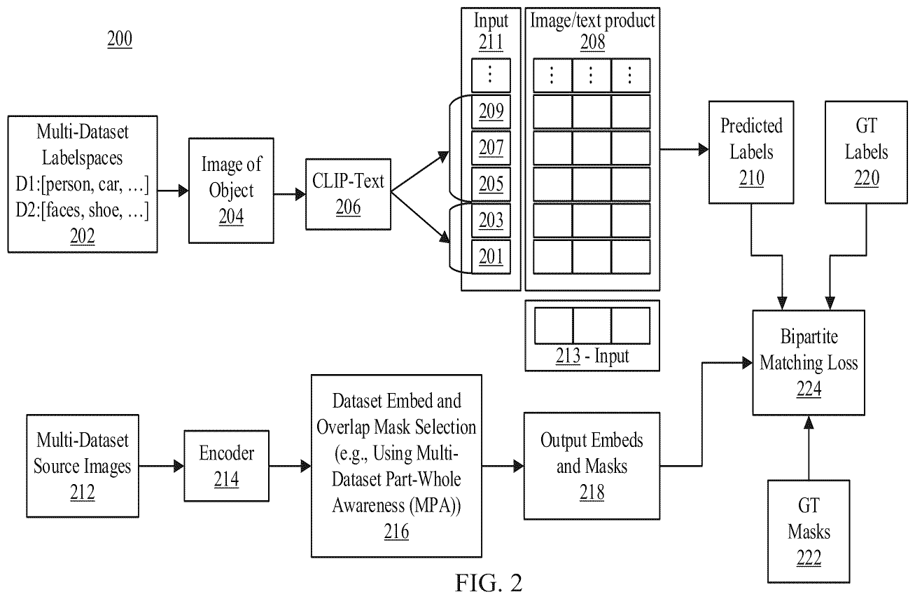

Moreover, it is to be appreciated that systems 200, 300, 400, 501, 503, 800, and 900, described below with respect to FIGS. 2, 3, 4, 5A, 5B, 8, and 9, respectively, are systems for implementing respective embodiments of the present invention. Part or all of processing system 100 may be implemented in one or more of the elements of systems 200, 300, 400, 501, 503, 800, and 900, in accordance with aspects of the present invention.

Further, it is to be appreciated that processing system 100 may perform at least part of the methods described herein including, for example, at least part of methods 200, 300, 400, 501, 503, 600, 700, and 800, described below with respect to FIGS. 2, 3, 4, 5A, 5B, 6, 7, and 8, respectively. Similarly, part or all of systems 200, 300, 400, 501, 503, 800, and 900 may be used to perform at least part of methods 200, 300, 400, 501, 503, 600, 700, and 800 of FIGS. 2, 3, 4, 5A, 5B, 6, 7, and 8, respectively, in accordance with aspects of the present invention.

As employed herein, the term “hardware processor subsystem,” “processor,” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 2, a high-level view of a system and method 200 for panoptic segmentation training using a multi-dataset part-whole awareness model, is illustratively depicted in accordance with embodiments of the present invention.

In various embodiments, in block 202, multi-dataset labelspaces can be organized to include a variety of object categories from multiple datasets, such as D1, which may encompass categories like [person, car, . . . ], and D2, which could incorporate categories like [face, shoe, . . . ]. This structure enables the system to manage and interpret diverse semantic annotations, facilitating a comprehensive approach to recognize and classify a wide range of object classifications that may differ significantly across datasets. This ability can enhance the model's generalization across datasets with varying label definitions, supporting effective training and accurate predictions. In blocks 201, 203, 205, 207, and 209, text descriptions for the objects can be generated or retrieved to correspond with the categories specified in the multi-dataset labelspaces. Blocks 201 and 203 can process categories from D1, and blocks 205, 207, and 209 may handle categories from D2. These blocks can generate detailed textual descriptions that are essential for creating text embeddings, which can be utilized in subsequent steps to enhance the alignment and integration of text and image data for more precise object recognition and segmentation.

In block 204, images featuring objects for segmentation can be inputted into the system. This block can manage the initial processing of these images, which might involve standardizing image formats, adjusting dimensions, and enhancing image quality through techniques such as contrast adjustment and color correction. These preprocessing steps can be tailored to optimize the images for feature extraction, ensuring that the visual data is in an optimal state for accurate analysis and processing by the encoder. In block 206, a Contrastive Language Image Pretraining (CLIP) model can be utilized and a CLIP-Text Object can utilize advanced neural network architectures to integrate and process both textual and visual data. This integration can leverage state-of-the-art techniques in natural language processing and computer vision to create robust embeddings that capture the nuanced interplay between the textual descriptions and the visual features of the objects. These embeddings can serve as a critical component in understanding and categorizing the objects within the images, providing a rich semantic context that can significantly enhance the model's segmentation capabilities.

In block 211, outputs from the CLIP-Text Object, which include text embeddings generated from the detailed descriptions in blocks 201, 203, 205, 207, and 209, can be formatted and aligned for integration with visual features. This alignment can be crucial for ensuring that the text embeddings accurately correspond with the visual data, facilitating a seamless combination of these two data types in the subsequent processing steps. In block 213, preprocessed images from block 204 can undergo further processing to extract visual features that are suitable for integration with the text embeddings from block 211. This process can involve the application of convolutional neural networks or other feature extraction methods that can analyze and distill the visual information into a format that is compatible with the text data, enhancing the system's ability to accurately match and integrate these different forms of data.

In block 208, an image/text product matrix can be created by performing a dot product between the text embeddings from block 211 and the visual features from block 213. This matrix can serve as a crucial element in the system's processing pipeline, enabling the model to effectively align and integrate the textual and visual data. The matrix can provide a comprehensive representation of the relationships between the text and image data, which can be instrumental in predicting the categories of objects within the images with higher accuracy and reliability. In block 210, predicted labels can be generated based on the sophisticated analysis of the image/text product matrix from block 208. These labels can be essential for identifying the object categories within the images, influenced by the integrated understanding of text and image data. The accuracy of these predictions can play a pivotal role in the effectiveness of the overall segmentation process, guiding the system in producing segmentation results that are both reliable and semantically coherent.

In block 212, a collection of source images from multiple datasets can be aggregated and prepared for encoding. This block can manage the collection, standardization, and preliminary processing of these images to ensure they are in a uniform format suitable for detailed analysis and feature extraction by the encoder in block 214. In block 214, an encoder can be utilized to extract and encode features from the images provided by block 212. This encoder can apply a variety of advanced deep learning techniques to analyze the image data and distill it into a condensed feature-rich format, which can be crucial for the accurate segmentation and categorization of objects.

In block 216, the Dataset Embed and Overlap Mask Selection Module (MPA Module) can be activated to manage the integration of features from the multi-dataset labelspaces with the encoded image features. This module can address and resolve potential conflicts arising from overlapping label definitions by applying selective masking strategies, ensuring that the semantic integrity of the dataset-specific categorizations is maintained. In block 218, output embeds and masks are produced, representing the final segmentation masks and their corresponding embeddings based on the predictions from block 210. These outputs can be vital for assessing the model's segmentation accuracy and are used in further evaluations against ground truth data.

In block 220, ground truth labels can serve as a reference standard against which the predicted labels from block 210 are evaluated. These labels can be crucial for training the model to accurately predict object categories, serving as a benchmark to measure the effectiveness of the training process and adjust the model's performance accordingly. In block 222, ground truth masks can delineate the exact boundaries of objects as annotated in the training datasets. These masks can be essential for evaluating the spatial accuracy of the model's segmentation outputs, ensuring that the model's predictions accurately reflect the actual outlines of the objects.

In block 224, a bipartite matching loss can be calculated to assess the alignment between the predicted labels and masks from block 218 and the ground truth labels and masks from blocks 220 and 222. This loss function can be used to quantitatively measure the model's performance, providing a metric for optimizing the model during training to enhance accuracy and reduce segmentation errors. The present invention effectively addresses the challenges of training a panoptic segmentation model across multiple datasets by managing part-whole relationships and dataset-specific label conflicts, producing robust and accurate segmentation outputs applicable across a wide range of visual contexts, in accordance with aspects of the present invention.

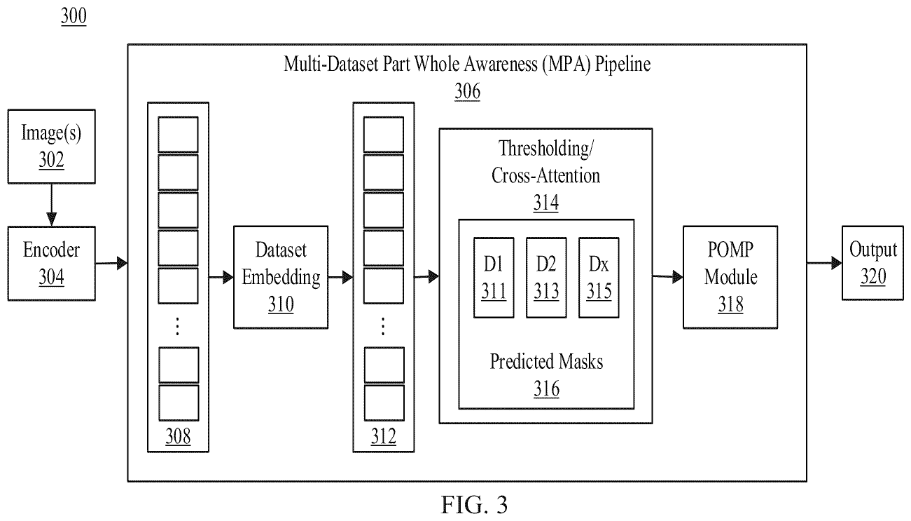

Referring now to FIG. 3, a diagram showing a system and method 300 for panoptic segmentation using a multi-dataset part-whole awareness pipeline, is illustratively depicted in accordance with embodiments of the present invention.

In various embodiments, in block 302, images can be inputted into the system for processing. This block can receive images from various sources, ensuring they are compatible with subsequent processing stages. These images can serve as the primary data source for the panoptic segmentation task, potentially containing multiple objects and scene types from diverse environments. The image input unit can handle a range of image formats and conditions, adapting them as necessary to maintain the integrity of the visual data for further analysis. In block 304, an encoder can process the input images to extract features. This encoder can utilize a deep neural network, such as a convolutional neural network (CNN) or a transformer-based model, to transform raw image data into a high-dimensional feature space. These features can capture essential visual cues like texture, shape, and context, crucial for accurate segmentation. The encoder's output provides a rich, condensed representation of the original image data, optimized for effective segmentation in subsequent stages.

In various embodiments, block 306 can include the core functionality of the system, where multiple processes can be orchestrated to handle the complexities of panoptic segmentation across various datasets. This pipeline can include mechanisms for cross-attention and thresholding, which can refine the segmentation process by focusing on relevant features and minimizing the impact of dataset-specific anomalies. In block 310, dataset embeddings can be generated to encode the specific characteristics and label spaces of different datasets involved in the training process. This embedding process can leverage pre-trained models or custom algorithms to map dataset identifiers and their associated properties into a continuous vector space. These embeddings can assist in aligning and normalizing the features extracted from diverse datasets, facilitating consistent handling across the multi-dataset training environment. Blocks 308 and 312 can involve the integration of processed image features with dataset embeddings. This integration can allow the system to maintain awareness of the source dataset for each image, preserving the context necessary for accurate segmentation while handling potentially conflicting annotations from different datasets.

In block 314, thresholding and cross-attention mechanisms can be applied to the integrated embeddings and features. These processes can enhance the distinction between different semantic categories and instances within the images, particularly where overlapping or closely related labels exist across datasets. By dynamically adjusting thresholds and focusing attention, the system can improve segmentation accuracy and consistency. Blocks 311, 313, and 315 can represent dataset-specific processing units for datasets D1, D2, and Dx, respectively. Each unit can handle the particularities of its corresponding dataset, applying customized rules and adjustments to accommodate unique label spaces and annotation standards. These units can ensure that the segmentation model's training and inference phases are sensitive to the nuances of each dataset, enhancing the model's overall performance and adaptability. In block 316, predicted masks can be generated based on the processed and integrated features and embeddings. These masks can delineate the boundaries and categories of various objects within each image, tailored to the combined knowledge extracted from multiple datasets.

In block 318, a Panoptic Overlapping Mask Prediction (POMP) module can finalize the segmentation process. This module can selectively combine and refine the predicted masks from block 316, resolving any conflicts and ensuring that each pixel in the output is assigned the most accurate label. The POMP module can be crucial for achieving high-quality panoptic segmentation outputs, especially in a multi-dataset training scenario where part-whole relationships and overlapping categories may present additional challenges. In block 320, the final output can be produced, which includes the unified panoptic segmentation maps. These maps can display comprehensive and instance-aware segmentations of the input images, reflecting the combined and harmonized understanding of the multiple datasets processed by the system. This output can be utilized in various applications that require detailed semantic understanding of visual scenes, such as autonomous driving, robotic navigation, and advanced image analysis systems. This output can be the final modified, masked images, which are the result of the panoptic segmentation process and can include unified panoptic segmentation maps that integrate the predicted masks for each category across multiple datasets. These maps can display, for example, both “thing” and “stuff” categories with clear instance boundaries, providing a comprehensive visual representation of the segmented elements within the image. Each pixel in the output image can be classified into the most appropriate category, with distinct segmentation masks applied to differentiate between overlapping and adjacent segments. This output can be especially useful for applications that rely on accurate and detailed image segmentation, such as autonomous driving systems, where precise understanding of the surrounding environment is necessary for real-time navigation and decision-making, in accordance with aspects of the present invention.

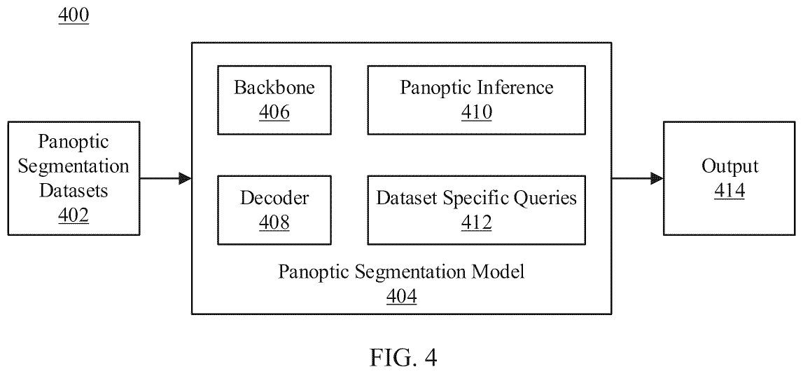

Referring now to FIG. 4, a diagram showing a system and method 400 for multi-dataset panoptic segmentation, is illustratively depicted in accordance with embodiments of the present invention.

In various embodiments, in block 402, panoptic segmentation datasets are utilized as the foundational input for the segmentation system. These datasets can encompass a diverse range of image categories and environmental settings, each dataset potentially adhering to its unique set of category definitions and annotations. This block can manage and preprocess these datasets to ensure they are ready for feature extraction and further analysis, accommodating variations in label spaces that stem from the heterogeneous nature of the data sources. In block 404, the panoptic segmentation model serves as the core processing unit within the system. This model can be based on a transformer architecture, optimized for handling complex image data and extracting detailed segmentation predictions. The model consists of several key components: a backbone for initial feature extraction, a decoder for deriving segmentation masks, and an inference mechanism for final mask adjustments and output generation.

In block 406, the backbone of the segmentation model can process incoming images to extract primary visual features. This component can use advanced neural network architectures, such as deep convolutional networks, to analyze and condense image data into a comprehensive set of features that capture both the textural and contextual nuances of the visual input. In block 408, the decoder can take the features extracted by the backbone and apply a series of transformations to predict detailed segmentation masks for each object in the image. This decoder can handle a fixed set of object queries and utilize dataset-specific embeddings to enhance its accuracy in distinguishing between similar categories across different datasets, thus mitigating potential label space conflicts.

In block 410, a panoptic inference unit can process the segmentation masks predicted by the decoder to produce a unified panoptic map. This component can include a novel inference algorithm designed to manage part-whole relationships effectively by allowing smaller masks to override larger ones when both have high confidence levels and the smaller mask is fully contained within the larger mask. This method ensures that each pixel is assigned the most accurate class and instance, enhancing the overall quality and usability of the segmentation output. In block 412, dataset-specific queries can be generated to tailor the segmentation process to the unique characteristics of each dataset used in the training. These queries can influence the decoder by providing context about which dataset an image originates from, enabling the model to adjust its predictions to align with the specific semantic and instance annotations of that dataset. This customization can significantly improve the model's ability to handle diverse datasets without sacrificing precision.

In block 414, the output of the system can be the final segmented images, where each pixel has been accurately classified into semantic categories and assigned to specific instances based on the unified panoptic map generated by the inference unit. The output can be used in various applications that require detailed image understanding, such as autonomous driving, robotic navigation, and advanced surveillance systems, providing comprehensive insights into the visual scene. The system and method 400 is designed to handle complex segmentation tasks across various datasets with high efficiency and accuracy, making it a valuable tool for applications requiring advanced image analysis capabilities, in accordance with aspects of the present invention.

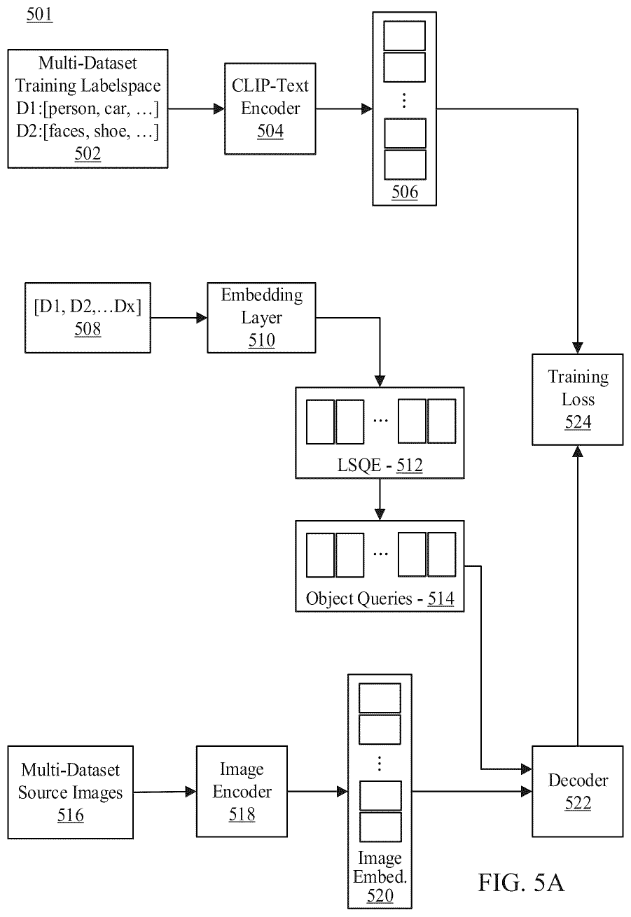

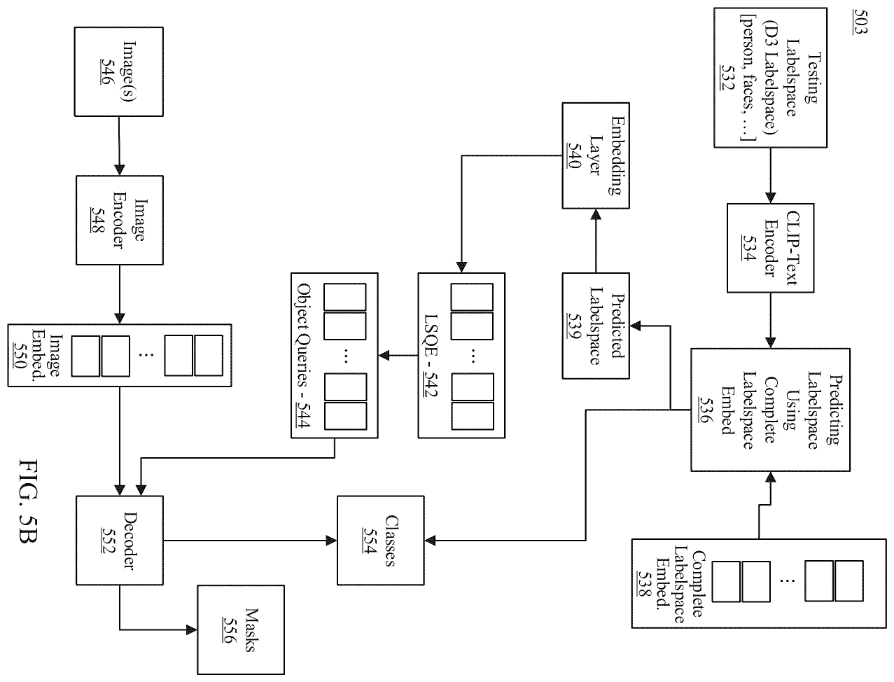

Referring now to FIG. 5A, a diagram showing a system and method 501 for multi-dataset panoptic segmentation training, is illustratively depicted in accordance with embodiments of the present invention.

In various embodiments, in block 502, a diverse collection of training datasets can be compiled, each characterized by a unique label space that includes various object categories such as “person,” “car,” “face,” and “shoe.” This compilation can serve as the foundation for training a panoptic segmentation model, aiming to equip the model with the capability to handle a wide array of visual and semantic discrepancies across datasets. This block can ensure that each label is accurately represented in the training process, enhancing the model's ability to generalize across datasets with potentially conflicting annotations. Additionally, the integration of multiple label spaces can facilitate a comprehensive understanding of the relationships and distinctions between categories, which can be especially useful for the model's performance in real-world scenarios requiring real-time decision making and system component adjustments for optimal system safety and/or performance.

Block 504 incorporates a CLIP-Text Encoder that can convert textual descriptions of dataset labels into high-dimensional embeddings. By leveraging natural language processing techniques within the CLIP framework, this encoder can generate semantic embeddings that capture the contextual nuances of each label. The process can enhance the model's interpretative capabilities, allowing it to associate visual data with textual information seamlessly. This encoding step is pivotal in creating a robust linkage between the diverse semantic labels and their visual counterparts, ensuring that the embeddings are optimized for subsequent integration with visual features. In block 506, the outputs from the CLIP-Text Encoder are textual embeddings that encapsulate the semantic essence of the dataset labels. These embeddings can be vital for training the segmentation model, providing a rich semantic layer that complements the visual inputs. By integrating these embeddings, the model can develop an enhanced understanding of the semantic content of the images, which can be utilized for accurately classifying and segmenting complex scenes.

Block 508 can manage the organization and indexing of embeddings to correspond with specific dataset labels. This function can involve mapping each embedding to a label identifier, facilitating a structured approach to handling the embeddings during the training phase. Proper indexing can ensure that the model leverages the correct semantic information for each image, crucial for maintaining consistency and accuracy in the training outputs. In block 510, an embedding layer can refine the indexed embeddings from block 508. This layer can further process the embeddings to align them with the neural network's architecture, optimizing them for improved interaction with the visual features extracted from the images. The refined embeddings can then be utilized more effectively within the model, enhancing the semantic resolution of the segmentation tasks.

Block 512 involves generating Label Space-Specific Query Embeddings (LSQE) which tailor the model's responses to the unique characteristics of each dataset's label space. These query embeddings can direct the segmentation process by adjusting the model's focus according to the specific semantic requirements of each label space, facilitating precise segmentation across diverse datasets. In block 514, object queries can be derived from the LSQE to guide the segmentation model in identifying and classifying different objects within the images. These queries can act as focal points for the model, highlighting areas of interest or concern within the visual data, and ensuring that the segmentation process is both accurate and relevant to the specific characteristics of each dataset. Block 516 involves the input of source images from the compiled multi-dataset collection. These images provide the visual data necessary for the model to apply the learned features and embeddings in practical segmentation tasks. The diversity of the image sources can challenge the model to adapt its strategies across different visual contexts, crucial for developing a versatile and robust segmentation capability.

In block 518, an Image Encoder can process the source images to extract essential visual features. This encoder, potentially employing advanced convolutional networks, can analyze the images to produce feature maps that highlight significant visual patterns and structures for utilization for performing accurate and effective segmentation. Block 520 generates image embeddings from the visual features extracted by the Image Encoder in block 518. These embeddings can encapsulate crucial visual information in a format that is readily integrable with the textual embeddings, facilitating a deeper, multimodal understanding of the images. In block 522, a Decoder can utilize the object queries along with both textual and image embeddings to execute the segmentation tasks. This component can synthesize the diverse inputs to predict segmentation masks that accurately reflect the semantic and visual content of the images. Block 524 calculates the training loss, which measures the effectiveness of the segmentation predictions against known ground truths. This metric can guide the optimization of the model, pinpointing areas where adjustments are needed to minimize errors and enhance the segmentation accuracy. This feedback loop can be utilized for refining the model's performance, ensuring it meets the stringent requirements of multi-dataset segmentation, in accordance with aspects of the present invention.

Referring now to FIG. 5B, a diagram showing a system and method 503 for multi-dataset panoptic segmentation inferencing, is illustratively depicted in accordance with embodiments of the present invention. This system and method 503 is designed to integrate various processes including image and text encoding, embedding refinement, and decoding to achieve accurate segmentation. The framework ensures that each component is tailored to handle the complexities of processing images across diverse label spaces effectively.

In various embodiments, in block 532, an array of labels from this exemplary designated D3 label space can be gathered to guide the inference operations of the segmentation model. This label space, which may include diverse categories such as ‘person’, ‘face’, and others, can be pivotal in providing the semantic framework necessary for accurately processing the input images. This block can enhance the model's ability to interpret the image data in relation to specific label characteristics, which is crucial for maintaining the consistency and relevance of the segmentation results across varying image sets. In block 534, the CLIP-Text Encoder can be utilized to transform the textual descriptions associated with the Testing Labelspace 532 into detailed semantic embeddings. This encoder leverages advanced natural language processing techniques to capture the nuanced meanings embedded within the text, converting these into a format that the segmentation model can process. The capability of this encoder to produce high-quality, meaningful embeddings is fundamental for ensuring that the model's interpretations of visual content are deeply informed by the corresponding textual metadata, thereby enhancing the overall accuracy of the segmentation process.

Block 536 involves using the Complete Labelspace Embedding to dynamically predict the most appropriate label space for the images undergoing analysis. This process can adaptively select and adjust the labels based on the specific visual and contextual cues present in the images, which can significantly enhance the model's flexibility and accuracy in real-time applications. The predictive mechanism in this block can evaluate various label configurations and their compatibility with the input images, optimizing the label selection to improve the precision and applicability of the segmentation outputs. In block 538, the Complete Labelspace Embedding stores a comprehensive set of vector embeddings that encompass all labels available within the system's database. This block acts as a critical resource during the predictive labeling process, providing a rich repository of semantic information that the model can draw upon to enhance its predictions. The embeddings in this block are meticulously maintained to ensure they remain current and reflective of the latest semantic developments and label additions, thus supporting the ongoing adaptability and learning capabilities of the segmentation model.

In block 539, the Predicted Labelspace can be generated based on the advanced predictive algorithms that utilize the refined embeddings from the Complete Labelspace Embedding 538. This sophisticated prediction mechanism considers the visual characteristics of the current images alongside semantic insights from the textual embeddings to select the most appropriate labels for each image. By dynamically aligning the segmentation process with the intricacies of the visual content, this block ensures that the label space used during segmentation is optimally suited to the specifics of the input, thus facilitating a higher degree of accuracy and relevance in the model's output. Block 540 involves an Embedding Layer that further processes and refines the predicted embeddings to align precisely with the segmentation model's requirements. This layer can adjust the embeddings for optimal compatibility, enhancing their utility by improving their precision and detail. This step is crucial for ensuring that the embeddings effectively communicate the necessary semantic and visual cues to the model, enabling it to perform segmentation with increased accuracy and efficiency.

In block 542, Label Space-Specific Query Embeddings (LSQE) can be generated to provide specific and detailed queries for the segmentation model. These embeddings can be tailored to the unique requirements of each predicted label space, enabling the model to focus its computational resources on relevant segments of the image. The LSQE process can involve sophisticated algorithms that interpret and transform the refined embeddings into actionable queries, which can direct the segmentation tasks with enhanced specificity and effectiveness. In block 544, Object Queries derived from the LSQE can be used to guide the segmentation model in identifying and classifying different objects within the images. These queries can pinpoint specific features or regions within the images that are significant for accurate classification and segmentation. The precision of these queries is important for the model's ability to discriminate between similar objects and to correctly apply the predicted labels, thereby ensuring the segmentation is both accurate and relevant to the input characteristics.

In block 546, images can be input into the system for processing. This block can handle a variety of image formats and conditions, applying initial preprocessing steps to standardize the images for consistent analysis. The preprocessing can include adjustments for lighting, alignment, and scaling, which are essential for preparing the images for detailed feature extraction and embedding processes that follow. In block 548, an Image Encoder processes the input images to extract critical visual features for utilization for segmentation. This encoder utilizes advanced techniques to analyze the visual data, producing high-quality image embeddings that capture the essential characteristics of each segment within the images. The effectiveness of this block ensures that the visual data is accurately represented in a form that complements the textual embeddings used in the segmentation model. In block 550, Image Embeddings can be created from the visual features extracted by the Image Encoder. These embeddings encapsulate detailed visual information that is crucial for the segmentation process. They provide a comprehensive visual representation that the Decoder can use, along with the textual embeddings, to perform detailed and accurate segmentation.

In block 552, a decoder can utilize both the object queries and the image embeddings to perform the segmentation tasks. This component synthesizes the diverse inputs to generate precise segmentation masks and classifications. The decoder's capability to integrate and interpret complex data is utilized effectively in producing detailed segmentation maps that accurately reflect the combined semantic and visual content of the images. In block 554, classes can be determined based on the outputs from the Decoder. This process can categorize the segmented parts of the images into defined classes as per the predicted label space. This classification can be utilized for structuring the segmentation outputs into usable formats, facilitating further analysis or practical applications of the segmented data. In block 556, masks that accurately delineate the boundaries of each classified segment within the images can be generated and/or applied. These masks can be utilized for visualizing the segmentation results, providing clear and distinct representations of each object or area as classified by the system. The detailed and precise nature of these masks is especially useful for applications where precise and/or real-time segmentation is necessary, such as in medical imaging, autonomous vehicle navigation, or detailed geographic imaging, in accordance with aspects of the present invention.

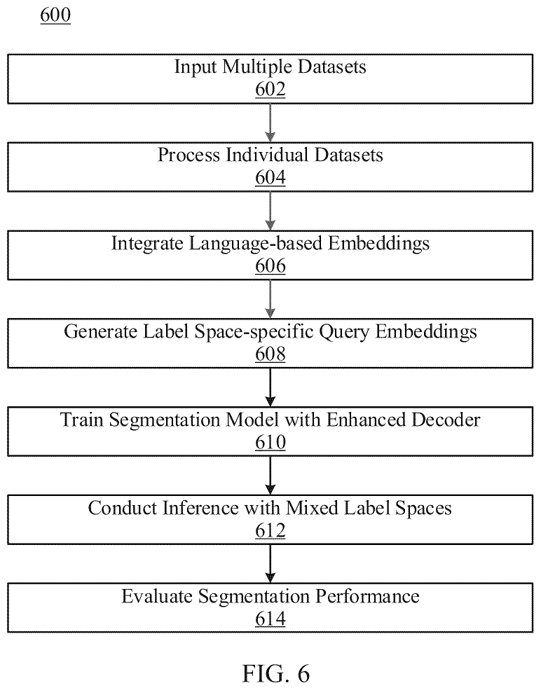

Referring now to FIG. 6, a diagram showing a method 600 for multi-dataset panoptic image segmentation training, is illustratively depicted in accordance with embodiments of the present invention.

In various embodiments, in block 602, multiple datasets can be inputted, each possessing its unique label space and ground truth annotations. These datasets are selected to cover a diverse range of categories and semantic labels, ensuring the model encounters varied semantic scenarios during training. This block sets the foundation for handling inconsistent semantics across datasets by providing a comprehensive set of input data that reflects the complexity of real-world visual scenes. In block 604, individual datasets can be processed to identify and categorize existing label spaces and semantics. This process may involve the analysis of label overlaps and the categorization of objects as either “thing” or “stuff” based on their countability and semantic significance. The insights gained here can aid in better preparing the model for the complexities of multi-dataset training.

In block 606, language-based embeddings of class names can be integrated using a CLIP-based model to create a unified semantic space. This step can allow the model to treat semantically similar categories across different datasets cohesively. The integration of language embeddings helps to maintain high semantic understanding despite the presence of label inconsistencies. In block 608, label space-specific query embeddings can be generated. These embeddings are designed to condition the transformer decoder on specific dataset semantics, facilitating the model's ability to handle conflicting label spaces. This approach allows for dynamic adaptation of the model's behavior based on the active label space during both training and inference. In block 610, the segmentation model can be trained using the modified Mask2Former framework that incorporates the enhancements from blocks 606 and 608. The model employs a multi-layer transformer decoder that processes images using both visual features and the newly integrated query embeddings. This training step is crucial for aligning the model's output with the complex and overlapping label spaces encountered in multi-dataset environments.

In block 612, inference can be conducted on new images using a combination of label spaces from the training datasets. The model can predict which label spaces to apply by matching the text embeddings of the class names with the query embeddings. This process ensures that the model is versatile and can handle arbitrary combinations of labels at inference time, significantly enhancing its practical utility in diverse applications. In block 614, the performance of the model can be evaluated across various benchmarks, including those specifically created to assess capabilities in mixed label space scenarios. Metrics such as mIoU for semantic segmentation, PQ for panoptic segmentation, and AP for instance segmentation can be used to quantify performance improvements and validate the effectiveness of the RESI framework. This method 600 shows can utilize the novel RESI framework for multi-dataset image segmentation training, addressing the challenge of inconsistent semantics across combined datasets. The approach leverages advanced techniques like language-based embeddings and label space-specific query embeddings to ensure robust performance, even in the face of semantic discrepancies, in accordance with aspects of the present invention.

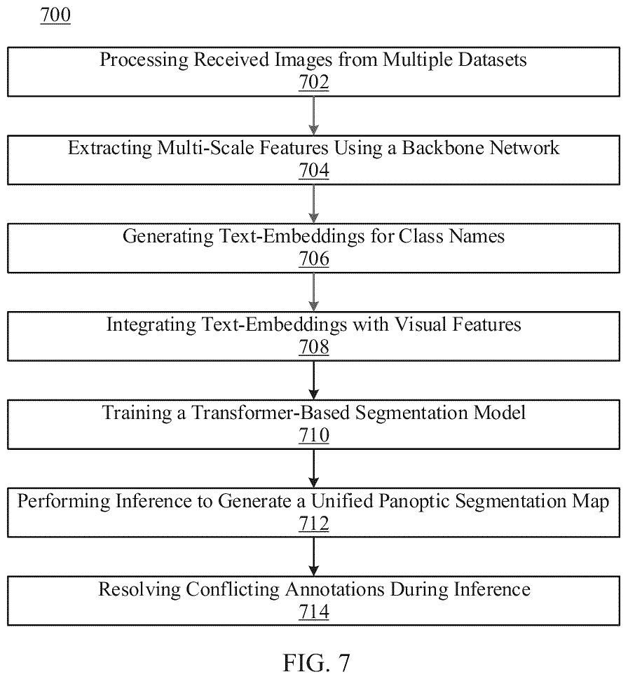

Referring now to FIG. 7, a diagram showing a method 700 for multi-dataset panoptic segmentation, is illustratively depicted in accordance with embodiments of the present invention.

In various embodiments, in block 702, images can be processed from multiple datasets, each including a unique label space. This block manages the preliminary processing of these images, which can involve tasks such as resizing, color correction, and other normalization processes for preparing the data for effective feature extraction. The diversity in datasets allows the model to encounter a wide range of visual scenarios, which can assist in developing robust segmentation capabilities. In block 704, multi-scale features can be extracted from the processed images using a backbone network. This network can be a convolutional neural network (CNN) or a transformer network that handles the computation of visual features at various scales and depths. The multi-scale feature extraction can be utilized for capturing both detailed and broad aspects of the images, providing a comprehensive feature set that supports complex segmentation tasks.

In block 706, text-embeddings for class names can be generated from the unique label spaces of each dataset. This process can utilize a pre-trained vision-and-language model to convert textual category descriptions into a dense vector format that encapsulates semantic meanings. These embeddings can facilitate a consistent treatment of category names across different datasets, bridging semantic gaps and enhancing the model's ability to generalize across diverse annotation standards. In block 708, the text-embeddings can be integrated with the visual features extracted from the images to create a unified semantic space. This integration can leverage methods like concatenation or feature fusion, allowing the model to correlate and combine textual and visual data effectively. The unified semantic space can enable the model to align semantic concepts with visual patterns more accurately, which is crucial for predicting precise segmentation outputs.

In block 710, a transformer-based segmentation model can be trained using the unified semantic space. This training involves adapting the model to accurately predict segmentation masks and classes for the received images, using the rich feature set developed from the integrated text and visual data. The transformer architecture can be particularly effective in handling this type of data due to its ability to model complex dependencies and relationships within the data. In block 712, inference can be performed using a novel panoptic inference algorithm to generate a unified panoptic segmentation map from the predicted segmentation masks and classes. This block can handle the task of resolving conflicts in segmentation predictions, especially those arising from the diverse label spaces of the training datasets. The inference process can ensure that each pixel is assigned the most appropriate semantic category and instance ID, resulting in a coherent and accurate panoptic map.

In block 714, the inference algorithm can resolve conflicting annotations from the multiple datasets by allowing a smaller mask to override a larger mask if both have confidences above a certain threshold and the smaller mask is fully contained within the larger mask and is of a different class. This specific mechanism can ensure that detailed features such as faces in the context of whole persons are not overshadowed by broader segmentations, maintaining the integrity and granularity of the panoptic output, in accordance with aspects of the present invention.

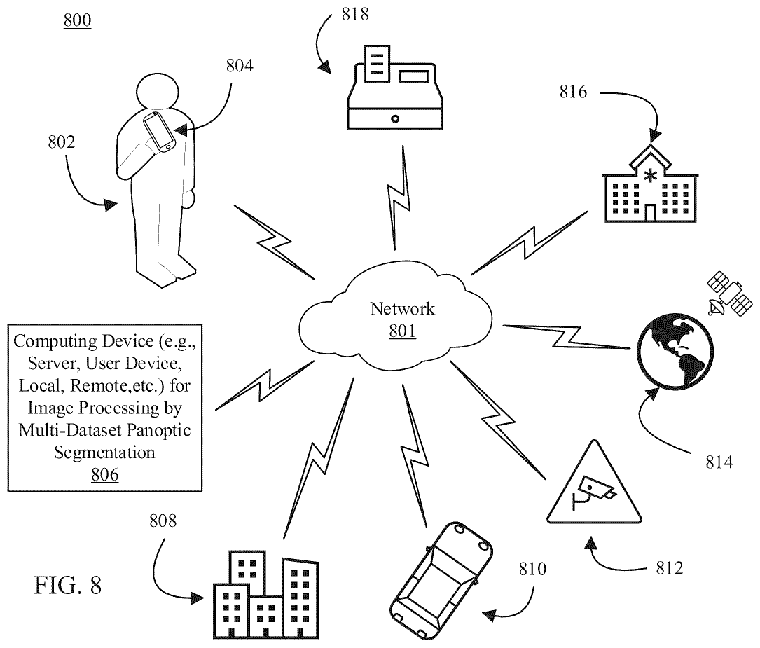

Referring now to FIG. 8, a diagram showing a high-level view of a system and method 800 for multi-dataset panoptic segmentation-based image processing across various computer vision and image processing tasks in multiple exemplary environments, is illustratively depicted in accordance with embodiments of the present invention.

In various embodiments, a computing network 801 can serve as a communication infrastructure connecting multiple devices and environments. This network can support a range of data transmission protocols and can handle high-bandwidth operations to facilitate real-time data exchange and coordination among the various system components. An end user 802, within this system, can engage with the technology using a user device 804. The user can initiate image processing tasks, provide input for customization of the Multi-Dataset Panoptic Segmentation, resolve inconsistent semantics, etc., and receive the processed outputs. The end user can interact with the system through a user interface that may allow for the specification of parameters, submission of images, or real-time feedback, which can be leveraged to fine-tune the processing algorithms.

The user device 804 can encompass a broad spectrum of technology, such as smartphones, tablets, laptops, and desktop computers. These devices can be equipped with specialized software that allows users to upload images for processing and make adjustments to images, queries, etc., in accordance with aspects of the present invention. The devices can also have varying processing capabilities, with some able to perform basic image processing tasks locally, while others may rely on remote servers for more complex computations. A computing device 806 (e.g., server, user device, local, remote, etc.) can be utilized for executing the intricate computations involved in the Multi-Dataset Panoptic Segmentation and other image processing tasks. This device can be a server, user device, or a combination of local and remote processing units, equipped with powerful CPUs or GPUs capable of performing the intensive calculations required for real-time utilization of the present invention. The computing device can operate the backend processes and further can host the algorithms that execute various tasks, in accordance with aspects of the present invention.

In block 808, the multi-dataset panoptic segmentation system can be employed to enhance urban planning and smart city management. The system can process diverse image data from urban environments, such as traffic conditions, pedestrian flows, and infrastructure status across multiple datasets, which may include satellite imagery, CCTV feeds, and aerial drone footage. By integrating and segmenting these datasets with high accuracy, the system can provide comprehensive insights into urban dynamics, facilitating efficient city planning, resource allocation, and emergency response optimization. The ability to handle datasets with varying label spaces is particularly valuable in urban settings where different agencies might use different systems for categorizing and annotating urban features.

In block 810, the system can significantly contribute to autonomous vehicle navigation systems. It can process real-time visual data from multiple sources, including onboard cameras and pre-existing geographical information systems, to generate accurate panoptic maps of the vehicle's surroundings. These maps include detailed classifications and localizations of all visible objects, such as other vehicles, pedestrians, road signs, and lane markings, which are crucial for safe and efficient navigation. The system's robustness against label space inconsistencies ensures reliable performance even when integrating datasets from different geographic regions or manufacturers. In block 812, the system can be applied to enhance surveillance and security systems. It can analyze footage from multiple security cameras across different locations, segmenting and identifying various elements such as individuals, vehicles, and objects in complex scenes. The ability to train from diverse datasets allows the system to adapt to various scenarios and lighting conditions, improving threat detection and situational awareness in security-critical environments like airports, shopping centers, and public squares.

In block 814, the system can be utilized for agricultural monitoring and management. By processing images from satellites, drones, and field cameras, the system can segment and classify different crops, assess plant health, and monitor pest and disease outbreaks. The integration of multiple agricultural datasets helps in achieving more accurate and detailed panoptic segmentation, facilitating precise intervention strategies, optimizing resource usage, and enhancing yield predictions. This can further include aiding in environmental monitoring by analyzing images from diverse ecological datasets, including forest regions, aquatic systems, and urban biomes. The system can detect changes in vegetation cover, water levels, and pollution patterns, contributing to efforts in climate change research, habitat preservation, and disaster management. The capability to seamlessly integrate and interpret panoptic data from varied sources is vital for tracking environmental changes accurately and implementing timely conservation measures.

In block 816, the system can transform medical imaging and analysis by applying its segmentation capabilities to diverse medical imaging datasets, such as MRI scans, X-rays, and ultrasound images. It can assist in the detection and segmentation of tumors, fractures, and other pathological features from a mix of imaging modalities, enhancing diagnostic accuracy and personalized treatment planning. The system's robustness in handling different medical annotation standards and imaging techniques ensures high reliability and adaptability in clinical environments. In block 818, the system can be applied to retail and inventory management, where it can analyze images from store cameras to monitor product placement, shelf arrangement, and customer interaction patterns. The ability to train from and apply panoptic segmentation to varied retail environments helps in optimizing store layouts, improving customer experience, and automating stock level assessments, thereby enhancing operational efficiency and profitability. It is to be appreciated that although the system and method 800 is illustratively depicted as being applied to the above-described specific environments, the present invention is versatile and thus can be utilized in any sort of environments across a plurality of distinct real-world applications, in accordance with aspects of the present invention.

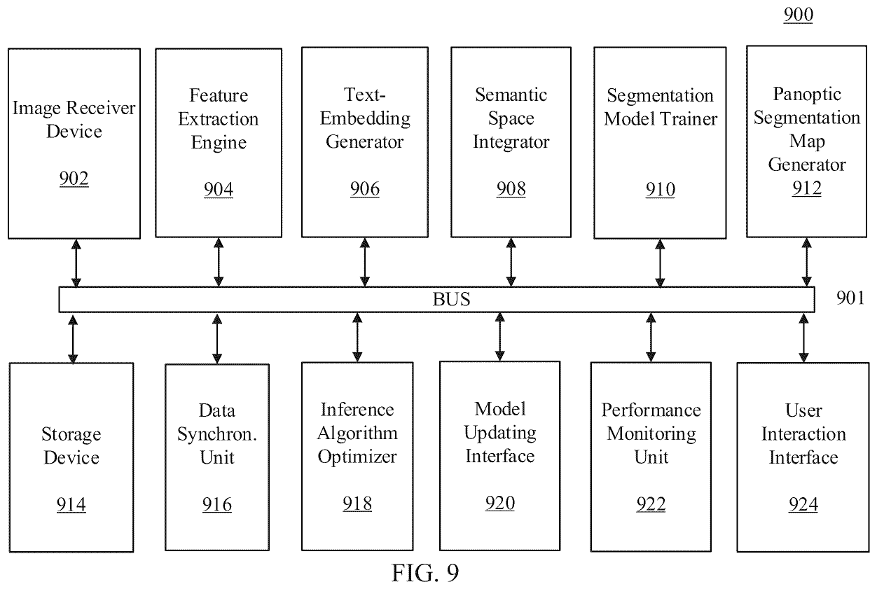

Referring now to FIG. 9, a diagram showing a system 900 multi-dataset panoptic segmentation-based image processing, is illustratively depicted in accordance with embodiments of the present invention.

In various embodiments, in block 902, an image reception unit can handle the intake of images from diverse datasets, ensuring that the visual data from various sources are correctly formatted and synchronized for consistent processing. This unit supports a variety of image types and sources, crucial for maintaining a versatile and robust input stream for the segmentation tasks. In block 904, a feature extraction engine can analyze received images to derive multi-scale visual features essential for detailed segmentation. Utilizing either deep convolutional neural networks or advanced transformer models, this engine extracts layers of features that capture both the macro and micro elements of the visual data, crucial for understanding complex scenes. In block 906, a text-embedding generator can process textual information from each dataset's label space to produce semantic embeddings. By employing a pre-trained vision-and-language model, this unit transforms class names and other textual descriptors into dense vector formats that capture the inherent semantic properties of each class, facilitating a deeper integration of textual and visual data.

In block 908, a semantic space integrator can merge the text embeddings with the extracted visual features to form a unified semantic space. This integration is fundamental for creating a cohesive representation where visual and textual data are aligned, enhancing the model's ability to accurately interpret and segment complex datasets. In block 910, a segmentation model trainer can utilize the unified semantic space to train a transformer-based segmentation model. This training involves adapting the model to effectively predict accurate segmentation masks and classes, leveraging the rich, integrated feature set provided by the earlier stages. In block 912, a panoptic segmentation map generator can compile the outputs from the segmentation model-specifically the masks and class predictions-into a comprehensive panoptic map. This unit uses sophisticated algorithms to ensure that all elements are correctly placed and classified, providing a detailed and actionable segmentation output.

In block 914, a storage device can archive all pertinent data, including raw input images, processed features, intermediate data, and final segmentation maps. This device ensures data availability and integrity for both real-time processing and historical analysis, supporting the system's operational and evaluative needs. In block 916, a data synchronization unit can manage the alignment and timing of data flows between the processing stages. This unit ensures that data transitions smoothly from one stage to another without bottlenecks or data loss, optimizing the overall efficiency of the segmentation process. In block 918, an inference algorithm optimizer can refine the algorithms used during the final inference stage to generate panoptic segmentation maps. This unit adjusts algorithm parameters in response to feedback from the system's output, aiming to enhance accuracy and reduce conflicts between overlapping segmentation labels from different datasets.

In block 920, a model updating interface can facilitate the incorporation of new data and insights back into the model training process. This interface allows for continuous learning and model refinement, ensuring the system remains effective as new datasets are added or existing datasets evolve. In block 922, a performance monitoring unit can track the effectiveness of the segmentation tasks, providing analytics on accuracy, speed, and reliability. This unit helps identify areas for improvement, supporting ongoing system enhancements to maintain high standards of performance. In block 924, a user interaction interface can provide system users with the ability to input parameters, receive outputs, and interact with the segmentation system. This interface supports customization of segmentation tasks and allows users to access detailed results for analysis or further processing. The system integration bus 901 supports communication and data transfer across all components of the system, ensuring that each system component can efficiently exchange information in real-time. This bus can be utilized for maintaining the coherence and timing of the segmentation process across the system architecture, in accordance with aspects of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for multi-dataset panoptic segmentation, comprising:
processing received images from multiple datasets to extract multi-scale features using a backbone network, each of the multiple datasets including a unique label space;
generating text-embeddings for class names from the unique label space for each of the multiple datasets;
integrating the text-embeddings with visual features extracted from the received images to create a unified semantic space;
training a transformer-based segmentation model using the unified semantic space to predict segmentation masks and classes for the received images; and
generating a unified panoptic segmentation map from the predicted segmentation masks and classes by performing inference using a panoptic interference algorithm.

2. The method of claim 1, wherein the backbone network comprises a convolutional neural network or a transformer network that processes the images to extract multi-scale visual features.

3. The method of claim 1, further comprising conditioning a transformer decoder on specific dataset semantics by applying dataset-specific query embeddings to object queries during the segmentation model training.

4. The method of claim 1, wherein the text-embeddings are generated using a pre-trained vision-and-language model that maps category names of different datasets into a single consistent space where semantic relations are preserved.

5. The method of claim 4, wherein the pre-trained vision-and-language model is Contrastive Language-Image Pre-training (CLIP) model for generating text-embeddings that map category names from different datasets into a consistent semantic space.

6. The method of claim 1, wherein the inference algorithm resolves conflicting annotations from the multiple datasets by allowing a smaller mask to override a larger mask if both have confidences above a certain threshold and the smaller mask is fully contained within the larger mask and is of a different class.

7. The method of claim 1, wherein the transformer-based segmentation model is trained to handle overlapping label spaces from the multiple datasets, enhancing a robustness and semantic understanding of the transformer-based segmentation model.

8. A system for multi-dataset panoptic segmentation, comprising:
a processor device; and
a memory storing instructions that, when executed by the processor device, cause the system to:
process received images from multiple datasets to extract multi-scale features using a backbone network, each of the multiple datasets including a unique label space;
generate text-embeddings for class names from the unique label space for each of the multiple datasets;
integrate the text-embeddings with visual features extracted from the received images to create a unified semantic space;
train a transformer-based segmentation model using the unified semantic space to predict segmentation masks and classes for the received images; and
generate a unified panoptic segmentation map from the predicted segmentation masks and classes by performing inference using a panoptic interference algorithm.

9. The system of claim 8, wherein the text-embeddings are generated using a pre-trained vision-and-language model that maps category names of different datasets into a single consistent space where semantic relations are preserved.

10. The system of claim 9, wherein the pre-trained vision-and-language model is a Contrastive Language-Image Pre-training (CLIP) model for generating text-embeddings that map category names from different datasets into a consistent semantic space.

11. The system of claim 8, wherein the processor device executes instructions to apply a panoptic inference algorithm that resolves conflicting annotations by prioritizing smaller masks over larger masks based on containment and class difference.

12. The system of claim 8, wherein the memory stores instructions that enable the system to adapt to varying label spaces from the datasets by employing language-based embeddings, thereby allowing the system to process images from new or unseen datasets without retraining.

13. The system of claim 8, wherein the transformer-based segmentation model is trained to handle overlapping label spaces from the multiple datasets, enhancing a robustness and semantic understanding of the transformer-based segmentation model.

14. The system of claim 8, wherein the panoptic inference algorithm resolves conflicting annotations from the multiple datasets by allowing a smaller mask to override a larger mask if both have confidences above a certain threshold and the smaller mask is fully contained within the larger mask and is of a different class.

15. A computer program product for multi-dataset panoptic segmentation, the computer program product comprising a computer readable storage medium having program instructions embodied therewith, the program instructions executable by a hardware processor to cause the hardware processor to:
process received images from multiple datasets to extract multi-scale features using a backbone network, each of the multiple datasets including a unique label space;
generate text-embeddings for class names from the unique label space for each of the multiple datasets;
integrate the text-embeddings with visual features extracted from the received images to create a unified semantic space;
train a transformer-based segmentation model using the unified semantic space to predict segmentation masks and classes for the received images; and
generate a unified panoptic segmentation map from the predicted segmentation masks and classes by performing inference using a panoptic interference algorithm.

16. The computer program product of claim 15, wherein the text-embeddings are generated using a pre-trained vision-and-language model that maps category names of different datasets into a single consistent space where semantic relations are preserved.

17. The computer program product of claim 16, wherein the pre-trained vision-and-language model is a Contrastive Language-Image Pre-training (CLIP) model for generating text-embeddings that map category names from different datasets into a consistent semantic space.

18. The computer program product of claim 15, wherein the program instructions cause the hardware processor to resolve conflicts in annotations from different datasets during inference by applying the panoptic algorithm for prioritizing smaller masks when they are fully contained within larger masks of a different class.

19. The computer program product of claim 15, wherein the program instructions enable adaptation to varying label spaces from the datasets by employing language-based embeddings to process images from new or unseen datasets without retraining.

20. The computer program product of claim 15, wherein the program instructions enable the hardware processor to evaluate the trained model's performance using metrics that assess the model performance of overlapping label spaces, enhancing its utility in diverse application scenarios, and wherein the panoptic inference algorithm includes steps for sequentially placing segmentation masks based on their confidence scores and sizes to effectively manage overlapping masks, ensuring accurate segmentation outcomes.
